(19) United States
(12) Patent Application Publication
(10) Pub. No.: US 2003/0070659 A1
(43) Pub. Date: Apr. 17, 2003

(54) Intake pipe type engine

(75) Inventors: Yusuke Kihara, Hitachi (JP); Toshiharu Nogi, Hitachinaka (JP); Yoshihiro Sukegawa, Hitachi (JP)

Correspondence Address: CROWELL & MORING LLP, INTELLECTUAL PROPERTY GROUP, P.O. BOX 14300, WASHINGTON, DC, 20044-4300, US

(73) Assignee: HITACHI, LTD.

(21) Appl. No.: 10/267,782

(22) Filed: Oct. 10, 2002

(30) Foreign Application Priority Data
Oct. 12, 2001 (JP) 2001-315772

(51) Int. Cl. F02M 1/00

(52) U.S. Cl. 123/470

(57) ABSTRACT

an intake pipe injection type engine, in which even if the air flow is generated in the intake pipe, the fuel is prevented from adhering to the inner wall of the intake pipe to aim at the decrease of the amount of the hydrocarbon exhaust, thereby the response of the fuel supply of the demanded air fuel ratio is improved. In an intake pipe injection type engine, in which the fuel injection valve is installed in the intake pipe, and the fuel is injected into the intake pipe, the fuel injection valve injects a main spray of which the spray angle is wide and the spray penetration is weak, and a lead spray of which the spray angle is narrow and the spray penetration is strong.

### BACKGROUND OF THE INVENTION

The present invention relates to an intake pipe injection type engine, in which the fuel injection valve is installed in the intake pipe, and the fuel is injected into the intake pipe, particularly to an intake pipe injection type engine, in which the fuel is prevented from adhering to the inner wall of the intake pipe to decrease the amount of unburnt hydrocarbon (HC).

In general, in an engine in which a fuel injection valve is installed in an intake pipe so that fuel is injected in the intake valve, fuel injected from the fuel injection valve into the intake pipe adheres to the wall surface of the intake pipe and a liquid film is formed thereon. The liquid film formed on this intake pipe wall surface enters the combustion chamber of the engine as the state of the liquid film without being evaporated in the intake pipe and, therefore, is exhausted as unburnt hydrocarbon (HC). Therefore, the exhaust gas exhausted from an exhaust pipe including the unburnt hydrocarbon (HC) is discharged into the atmosphere, and invites the deterioration of the state of exhaust gas.

Moreover, since the fuel injected into the intake valve from the fuel injection valve adheres to the intake pipe to form the liquid film, a part of the fuel injected from the fuel injection valve is not supplied to the combustion chamber immediately after the injection. Namely, the time delay is occurred when entering in the combustion chamber, and, therefore, the response is deteriorated.

Then, in the past, a method of adjusting the position and the shape of the intake pipe and the fuel injection valve is proposed in the Japanese Patent Application Laid-Open No. 5-240056, in order to prevent the fuel from colliding with the wall of the intake pipe, in which the intake pipe is inclined to the exhaust pipe side so that longitudinal swirl can be generated, and the fuel injection valve is installed in the intake pipe so that the direction of injection of the fuel may be directed to a center part of the combustion.

Moreover, a method of making fuel spray minute by devising the position of the injection aperture installed in the nozzle of the fuel injection valve is proposed recently as shown in the Japanese Patent Application Laid-Open No. 11-72067.

However, when the fuel is injected in operating conditions that the pressure in the intake pipe becomes negative pressure such as under low load at the exhaust stroke, the spitting where combustion gas flows backward from the combustion chamber at positive pressure to the intake pipe is caused, when the intake valve opens to supply the fuel to the combustion chamber in the former method.

As a result, the fuel injected from the fuel injection valve is blown off in the intake pipe to adhere to the wall surface of the intake pipe, and the liquid film is formed on the wall surface. Therefore, the deterioration of the state of exhaust gas cannot be improved.

In addition, when the fuel is injected at the intake stroke, the fuel is injected from the fuel injection valve in the intake pipe. At the same time, the intake valve is opened and the piston is reduced. Thereby, the fuel injected into the intake pipe is inhaled by negative pressure. As a result, the fuel spray injected from the fuel injection valve is disturbed by the air flow generated in the intake pipe. The fuel spray adheres to the inner wall of the intake pipe to form the liquid film thereon. Therefore, the deterioration of the state of exhaust gas cannot be improved.

Moreover, since the fuel spray injected from the fuel injection valve is made minute in the latter method, it is easy to evaporate the spray fuel by making this fuel spray minute. However, the fuel spray made minute comes to be influenced easily by the air flow generated in the intake pipe because minute fuel spray is light. Therefore, the fuel spray injected from the fuel injection valve is disturbed by the air flow generated in the intake pipe, and the adhesion to the intake pipe wall sometimes increases.

### SUMMARY OF THE INVENTION

An object of the present invention is to provide an intake pipe injection type engine, in which even if the air flow is generated in the intake pipe, the fuel is prevented from adhering to the inner wall of the intake pipe to aim at the decrease of the amount of the hydrocarbon exhaust, thereby the response of the fuel supply of the demanded air fuel ratio is improved.

The feature of the present invention resides in an intake pipe injection type engine, in which the fuel injection valve is installed in the intake pipe, and the fuel is injected into the intake pipe, wherein the fuel injection valve injects a main spray of which the spray angle is wide and the spray penetration is weak, and a lead spray of which the spray angle is narrow and the spray penetration is strong.

The adhesion of fuel to the wall can be decreased, the hydrocarbon is decreased, and the response can be improved by injecting lead spray of which the spray angle is narrow and the spray penetration is strong, preceding to the main spray of which the spray angle is wide and the spray penetration is weak according to such a configuration.

### BRIEF DESCRIPTION OF DRAWINGS

FIG. 1 is a configuration view of the engine in a first embodiment of an intake pipe injection type engine according to the present invention.

FIG. 2 is a view showing the installation on the fuel injection valve of the multiple-aperture plate installed in the fuel injection valve shown in FIG. 1.

FIG. 3 is a view showing the state of fuel spray injected from the fuel injection valve shown in FIG. 1.

FIG. 4 is a view showing the operation of the fuel injection valve in the embodiment shown in FIG. 1, wherein the relation among the opening and closing time of intake valve, the opening and closing time of the exhaust valve, and the time of injection of fuel is shown.

FIG. 5 is a view showing the state of injection seen from the side of the engine, which is at 20° before the top dead center, the later period of the exhaust stroke in the operation under the low load condition, and the injection in the exhaust stroke.

FIG. 6 is a top view showing the state of injection shown in FIG. 5

FIG. 7 is a A view showing the state of injection seen from the side of the engine, which is at 10° after the top dead center, the previous period of the intake.

FIG. 8 is a view showing the state where the injection of fuel is disturbed by the spitting from the combustion chamber, and the fuel is adhered to the inside wall of the intake pipe to form the liquid film.

FIG. 9 is a view showing the state where the lead spray of fuel spray has been counterbalanced to the air flow of the spitting from the combustion chamber.

FIG. 10 is a view showing the appearance of spray when fuel spray which has only the main spray is used in the intake stroke.

FIG. 11 is a view showing the state of spray by the fuel injection valve shown in FIG. 2.

FIG. 12 is a view showing a multiple-aperture plate having the different arrangement of injection apertures installed in the fuel injection valve shown in FIG. 1.

FIG. 13 is a view showing a multiple-aperture plate having the further different arrangement of injection apertures installed in the fuel injection valve shown in FIG. 1.

FIG. 14 is a view showing a multiple-aperture plate in a second embodiment of the intake pipe injection type engine according to the present invention.

FIG. 15 is a view where the spray form of fuel spray injected from the fuel injection valve with the multiple-aperture plate shown in FIG. 14.

FIG. 16 is a view showing the state of injection seen from the side of the engine, which is at 20° before the top dead center, the later period of the exhaust stroke in the operation under the low load condition, and the injection in the exhaust stroke.

FIG. 17 is a view showing the state of injection seen from the side of the engine, which is at 10° after the top dead center, the previous period of the intake.

FIG. 18 is a view showing the state where the injection of fuel is disturbed by the spitting from the combustion chamber, and the fuel is adhered to the inside wall of the intake pipe to form the liquid film.

FIG. 19 is a configuration view of the engine in a third embodiment of the intake pipe injection type engine according to the present invention.

FIG. 20 is a view showing a multiple-aperture plate installed in the point of one fuel injection valve shown in FIG. 19.

FIG. 21 is a view showing a multiple-aperture plate installed in the point of the other fuel injection valve shown in FIG. 19.

FIG. 22 is a view showing the state of injection seen from the side of the engine, which is at 20° before the top dead center, the later period of the exhaust stroke in the operation under the low load condition, and the injection in the exhaust stroke.

FIG. 23 is a view showing the state of injection seen from the side of the engine, which is at 10° after the top dead center, the previous period of the intake.

FIG. 24 is a view showing the state where the lead spray of fuel spray has been counterbalanced to the air flow of the spitting from the combustion chamber.

FIG. 25 is a view showing the state of spray by the fuel injection valve shown in FIG. 19.

### DETAILED DESCRIPTION OF THE PREFERRED EMBODIMENTS

Hereafter, embodiments of the present invention will be explained.

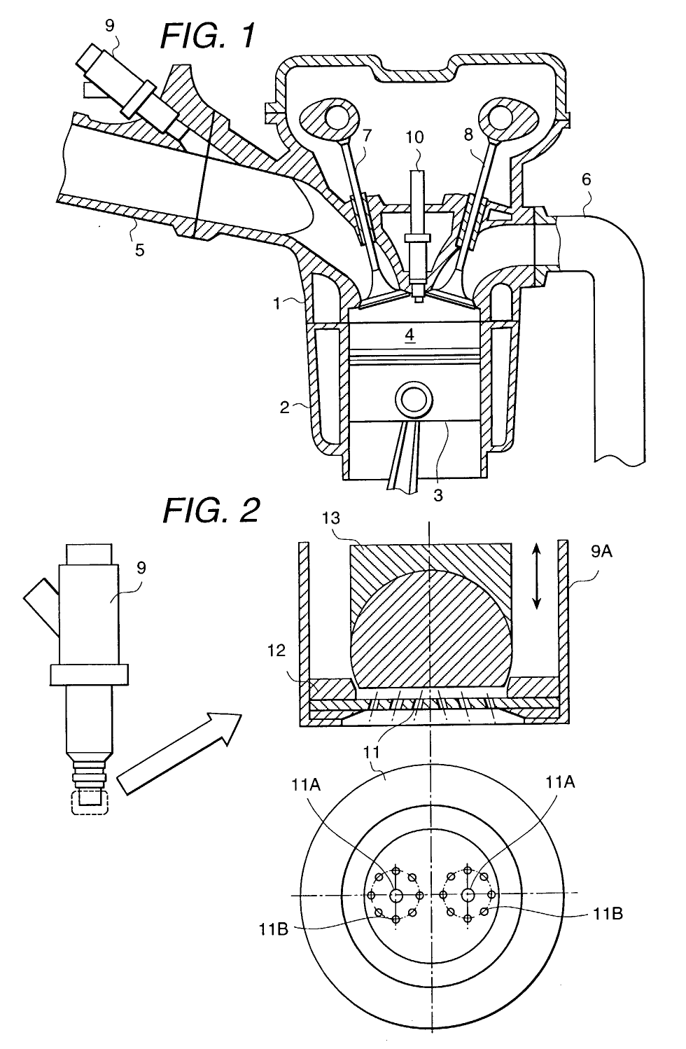

An embodiment of an intake pipe injection type engine according to the present invention is shown in FIG. 1.

FIG. 1 shows the side of the engine in schematic form. In FIG. 1, combustion chamber 4 is formed with cylinder head 1, cylinder block 2, and piston 3. This piston 3 is inserted in cylinder block 2, and the crown side (top face) is formed to the plane.

Moreover, two intake ports and two exhaust ports is installed in combustion chamber 4. Intake pipe 5 is connected in these two intake ports and exhaust pipe 6 is connected to these two exhaust ports. And, intake valve 7 for opening and shutting the opening is installed in each of two intake ports and exhaust valve 8 for opening and shutting the opening is installed in each of two exhaust ports.

Throttle valve (not shown) for adjusting the amount of the air flow inhaled into combustion chamber 4 and fuel injection valve 9 are installed in the upstream of intake pipe 5. The position where this fuel injection valve 9 is installed in intake pipe 5 is a position where the fuel can be injected in intake pipe 5 aiming at intake valve 7. In addition, sparking plug 10 for igniting the fuel air-fuel mixture supplied in combustion chamber 4 is installed on the upper center of combustion chamber 4.

Fuel injection valve 9 is configured as shown in FIG. 2. Multiple-aperture plate 11 is installed in the frame body 9A at the point of fuel injection valve 9. This multiple-aperture plate 11 is fixed to the frame body 9A at the point of fuel injection valve 9 by guide 12. Valve element 13 is installed at the position opposed to this multiple-aperture plate 11. This valve element 13 can be moved up and down. This valve element 13 connects or disconnects to guide 12 according to the vertical motion. The space is given between valve element 13 and guide 12 by valve element 13 rising with respect to guide 12, and the fuel flows through the space into multiple-aperture plate 11.

Two kinds of the injection apertures 11A and 11B with different diameters, large and small diameters, are installed in this multiple-aperture plate 11. In FIG. 2, a plurality of small injection apertures 11B are arranged on the concentric circle centering on the large injection aperture 11A. And, These two kinds of the injection apertures 11A and 11B with different diameters, large and small diameters, are inclined so that large injection aperture 11A may aim at the skirts of intake valve 7 and small injection aperture 11B may aim at the whole intake valve 7, when fuel injection valve 9 is installed in intake pipe 5.

One large injection aperture 11A and eight small injection apertures 11B are installed in multiple-aperture plate 11 shown in FIG. 2. However, the number and the positions of injection apertures do not put limitations on the present invention. It is enough if one large injection aperture 11A and one small injection aperture 11B are provided in the present invention. Thus, by providing large injection aperture 11A and small injection aperture 11B, a droplet with large diameter is injected from the injection aperture 11A and a droplet with small diameter from small injection aperture 11B when the fuel is injected.

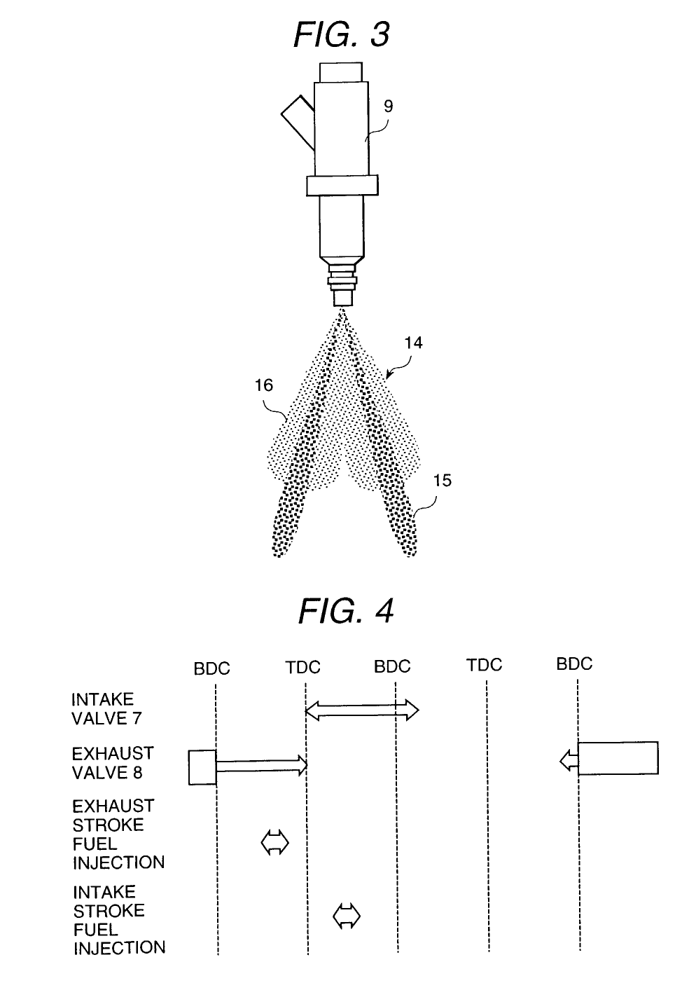

The kinetic momentum (dispersion speed) of the large droplet is larger than that of small droplet, and fuel spray travel becomes longer, when the fuel is injected from fuel injection valve 9 which such multiple-aperture plate 11 is installed in the frame body 9A at the point of the valve. Therefore, the shape of the fuel spray injected from fuel injection valve 9 in which multiple-aperture plate 11 is installed is as shown in FIG. 3. That is, fuel spray 14 injected from fuel injection valve 9 is composed of lead spray 15 injected precedently from large injection aperture 11A of multiple-aperture plate 11, of which fuel spray travel is longer, and main spray 16 injected succedently from small injection aperture 11B of multiple-aperture plate 11, of which fuel spray travel is shorter. The area ratio of the injection aperture is decided so that the mass ratio of lead spray 15 and main spray 16 may become about 1:3 (=The mass of lead spray:that of the main spray). And, the diameter of each injection aperture is decided so as to become this area ratio of the injection aperture.

Next, the operation of fuel injection valve 9 will be explained by using FIG. 4-FIG. 8.

The relation among the opening and closing time of intake valve 7, the opening and closing time of the exhaust valve 8, and the time of injection of fuel is shown in FIG. 4. In FIG. 4, there is no operating state in which intake valve 7 and exhaust valve 8 open at the same time, and, therefore, the backflow of exhaust gas is not considered. Further, the fuel injection time is between 90°-60° (crank angle) before the suction top dead center in case of the injection at the exhaust stroke, and it is between 30°-60° (crank angle) after the top dead center in case of the injection at the intake stroke.

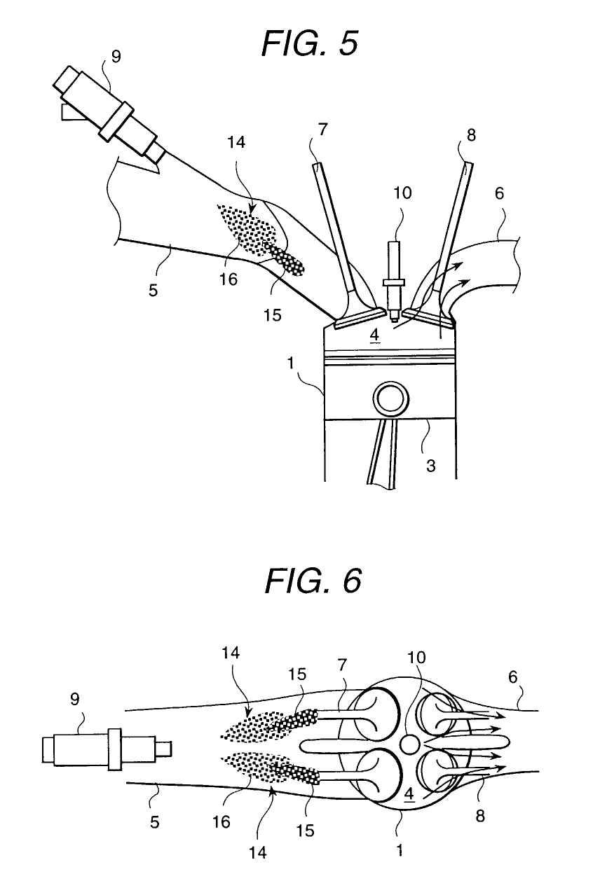

First of all, the injection at the exhaust stroke, the operation under low load condition will be explained. FIG. 5 shows the state of injection seen from the side of the engine, which is at 20° before the top dead center, the later period of the exhaust stroke. Moreover, FIG. 6 is a top view of one shown in FIG. 6.

In FIG. 5 and FIG. 6, exhaust valve 8 is still open, and the burnt combustion gas of combustion chamber 4 is already pushed out to exhaust pipe 6. Moreover, intake valve 7 is not open yet, and the air flow is hardly generated in intake pipe 5 under such a condition. Fuel spray 14 composed by lead spray 15 and main spray 16 injected from fuel injection valve 9 progresses toward intake valve 7 without being disturbed by the air flow in intake pipe 5, because the air flow is not caused in intake pipe 5 like this. At this time, lead spray 15 which composes fuel spray 14 is preceded main spray 16 because the diameter of the droplet is large and progresses toward intake valve 7.

When 20° burnt before the top dead center at the later stage of the exhaust stroke as shown in FIG. 5 and FIG. 6, the throttle valve is shut and the amount of intake air is decreased, because under the low load condition such as idling, the fuel injection amount is small and the combustion is performed at the theoretical air fuel ratio (A/F) 14.7 which is the stoichiometric mixture. Therefore, the pressure in intake pipe 5 is low compared with pressure in combustion chamber 4 under the low load conditions.

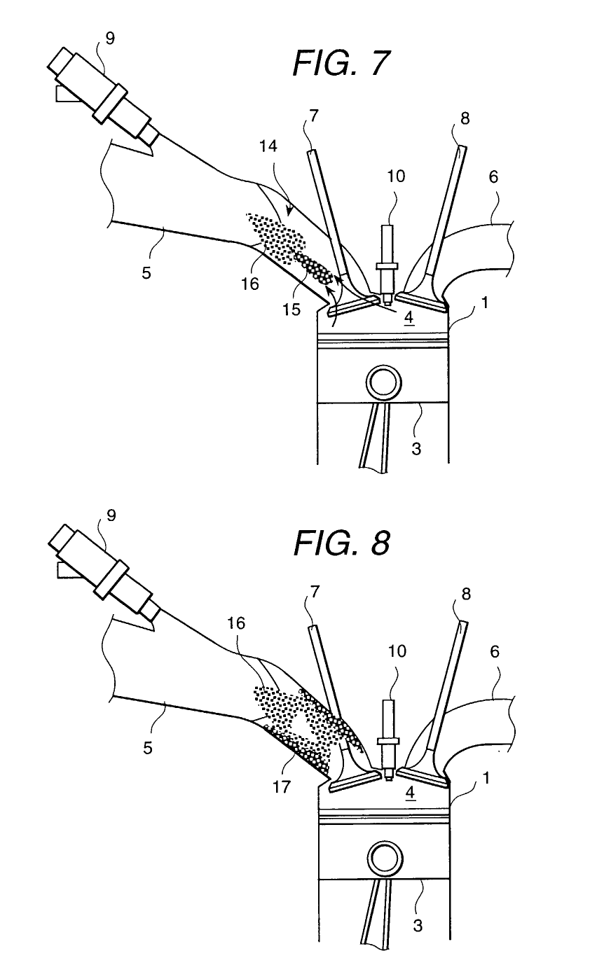

The state of injection seen from the side of the engine, which is at 10° after the top dead center, the previous period of the intake stroke is shown in FIG. 7.

FIG. 7 shows the state that intake valve 7 began to open a little from the state that both intake valve 7 and exhaust valve 8 shut at the exhaust stroke shown in FIG. 5 and FIG. 6.

In FIG. 7, when intake valve 7 begins to open a little, the pressure in intake pipe 5 is negative and the pressure in combustion chamber 4 is positive just when intake valve 7 is opened. Therefore, the spitting where combustion gas flows backward from combustion chamber 4 to intake pipe 5 by pressure difference in intake pipe 5 and combustion chamber 4 is caused.

lead spray 15 of fuel spray 14 collides with the air flow of the combustion gas generated by the spitting in intake pipe 5, preceding to main spray 16, when the spitting of combustion gas from this combustion chamber 4 to intake pipe 5 is caused.

With regard to the state in which lead spray 15 of such fuel spray 14 collides with the air flow of the combustion gas generated by the spitting, preceding to main spray 16, if a fuel injection valve with no installation of multiple-aperture plate 11 at the point of fuel injection valve 9 is used, which provides the spray having the conventional spray shape (for instance, the shape of the spray having only the main spray), the spray is disturbed by the spitting from combustion chamber 4 as shown in FIG. 8. As a result, a lot of fuels adhere to the wall surface of intake pipe 5 and liquid film 17 is formed. This liquid film 17 will inflow combustion chamber 4 as the liquid (the state of liquid film 17) without being evaporated, because the temperature in intake pipe 5 is almost near normal. It is not possible to burn completely when it inflows combustion chamber 4 in the state of liquid film 17 like this. Therefore, it is emitted as unburnt hydrocarbon (HC). Further, the time delay entering of the fuel in combustion chamber 4 is occurred, and the response to the best air-fuel ratio is deteriorated.

Moreover, although it is possible to hope for the improvement of the evaporation speed by an increase in the surface area when fuel spray made minute is used. The fuel spray comes to be influenced easily by the spitting from combustion chamber 4, and there is a possibility that the amount of the adhesion to the wall surface of intake pipe 5 increases. Moreover, when spray which has only the lead spray in which the fuel is concentrated by narrowing the angle of spray is used, fuel spray 14 hardly receives the influence of the air flow owing to the strong spray penetration, collides with intake valve 7, and forms the liquid film on the surface of intake valve 7. However, it is not possible to burn completely when the droplet generated from this liquid film by repulsing or tearing off enters combustion chamber 4, because the size of the droplet is large. As a result, unburnt hydrocarbon (HC) is produced. Moreover, the response is deteriorated because the amount of the adhesion increases.

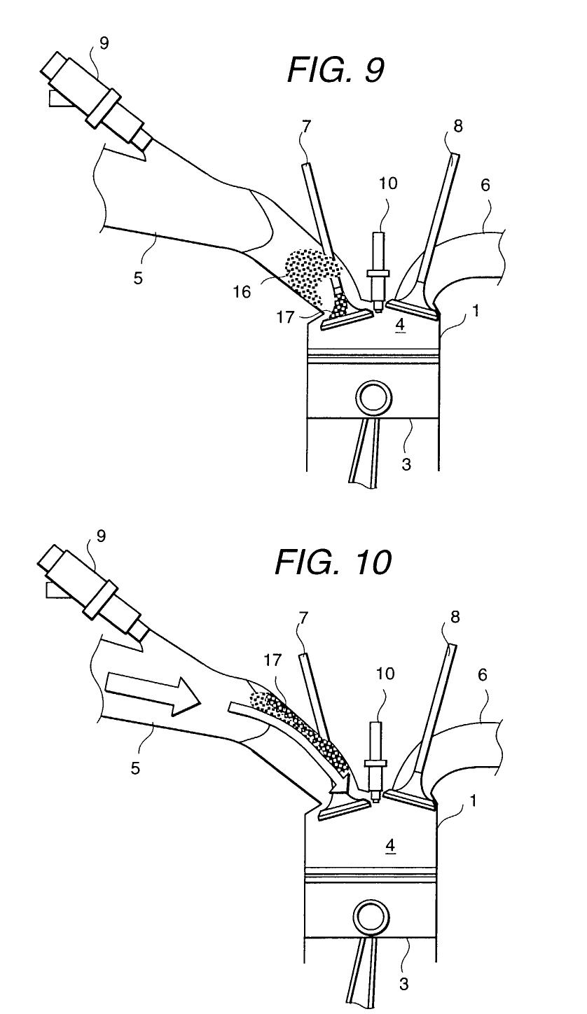

On the contrary, in the embodiment shown in FIG. 2. lead spray 15 of fuel spray 14 collides with the air flow of the spitting from combustion chamber 4, and will counterbalance the power of the air flow of the spitting from combustion chamber 4 as shown in FIG. 9. Because the power of the air flow of the spitting from combustion chamber 4 counterbalanced to lead spray 15 disappears like this, the fuel spray comes not to be blown off easily by the air flow of the spitting. Therefore, the fuel adhesion to the wall surface of intake pipe 5 can be decreased compared with the fuel spray only by the main spray in the prior art. Moreover, there is no delay in sending the fuel injected from fuel injection valve 9 into combustion chamber 4, and the response is improved. In this case, lead spray 15 reaches intake valve 7 and collides with intake valve 7 to form some liquid films 17, although it is counterbalanced to the air flow of the spitting from combustion chamber 4. However, the fuel amount of lead spray 15 is little as a ratio compared with the whole fuel amount, and the thickness of liquid film 17 is very thin. Therefore, a serious problem is not caused, because the size of the droplet generated by repulsing or tearing off is small enough to evaporate.

When piston 3 descends in combustion chamber 4 from the state shown in FIG. 9, the air in intake pipe 5 is inflowed in combustion chamber 4 from the opening of intake valve 7,and lead spray 15 and main spray 16 can form the air-fuel mixture with this air in combustion chamber.

Next, the operation under low load condition in the injection at the intake stroke will be explained.

When intake valve 7 opens and piston 3 descends in the intake stroke, the air in intake pipe 5 is inhaled from the opening of intake valve 7 in combustion chamber 4, and strong air flow is generated in intake pipe 5. the injection at the intake stroke differs from the jet at the exhaust stroke, and the air flow is generated in intake pipe 5 at the fuel injection time like this.

The appearance of spray when the fuel spray having only the main spray like the prior art is used is shown in FIG. 10. Because intake pipe 5 connected with combustion chamber 4 of cylinder head 1 has a gradual curvature, the fuel spray injected from fuel injection valve 9 is flowed to by the air flow generated in intake pipe 5 when conventional fuel spray shown in FIG. 10. It adheres to the wall surface of intake pipe 5 to form liquid film 17. Therefore, HC may be increased and the response may be deteriorated.

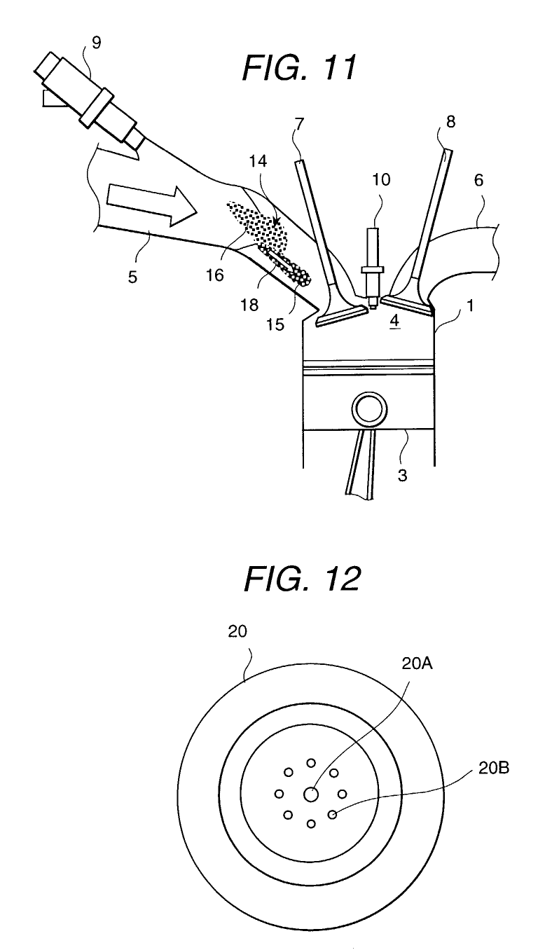

FIG. 11 shows the appearance of spray by fuel injection valve 9 shown in FIG. 2.

In FIG. 11, surrounding air gets involved by strong penetration lead spray 15 directed to intake valve 7 when fuel spray 14 is injected from fuel injection valve 9. As a result, jet 18 directed to intake valve 7 is generated in intake pipe 5 besides the air flow generated at the first stage. On the other hand, it is easy for main spray 16 of fuel spray 14 injected from fuel injection valve 9 to be thrown into the air flow because main spray penetration is weaker than lead spray 15. This main spray is induced to jet 18 generated by lead spray 15 and progressively toward intake valve 7, and then inflow in combustion chamber 4 without adhering to the wall surface of intake pipe 5. Moreover, although lead spray 15 of fuel spray 14 injected from fuel injection valve 9 collides with intake valve 7, the liquid film formed by the collision is negligible because the amount of lead spray 15 is few compared with the whole fuel amount.

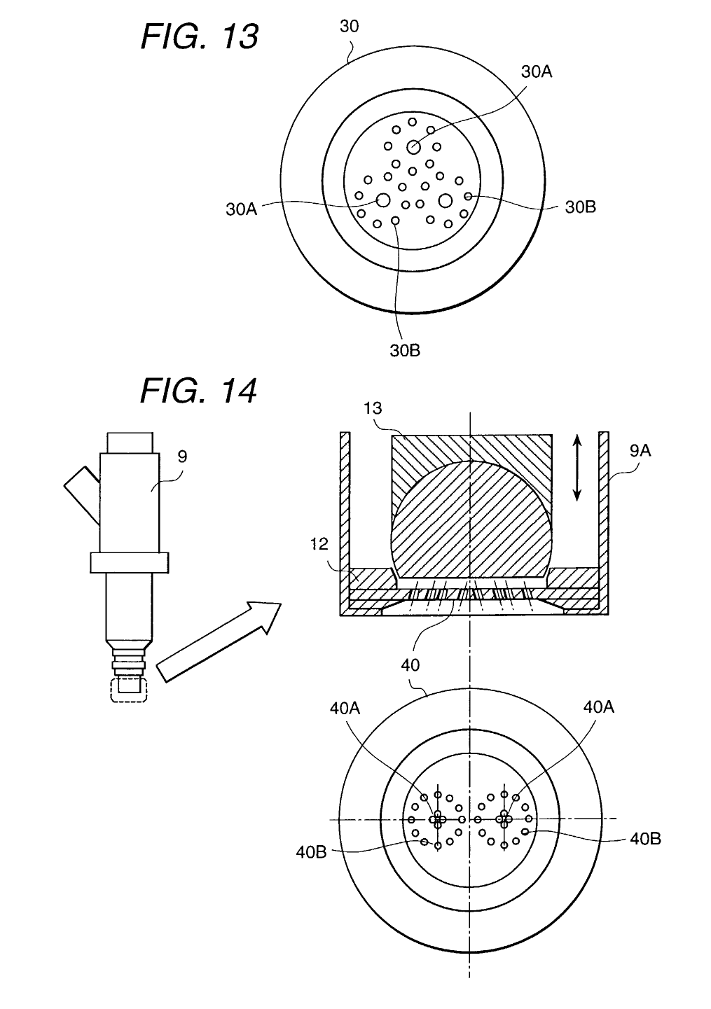

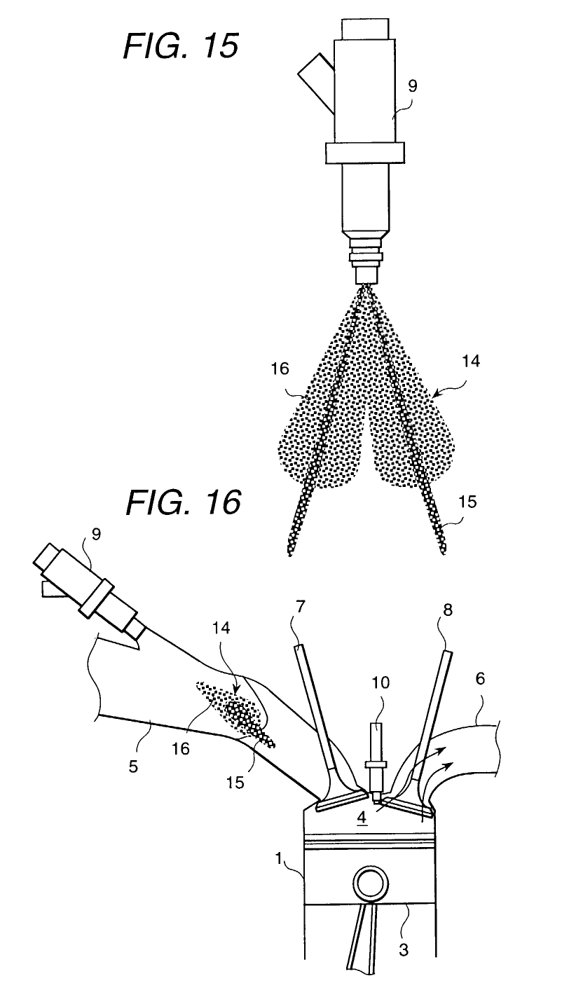

Although an example is adopted in which two intake pipes 5 are installed for one cylinder in the embodiment shown in FIG. 2, similar effects can be obtained by using the configurations in which one intake pipe 5 is provided for one cylinder, or more than three intake pipes 5 are installed for one cylinder. For instance, in case that one intake pipe 5 is provided for one cylinder, multiple-aperture plate 20 as shown in FIG. 12 is provided. Further, in case that three intake pipes 5 are provided for one cylinder, multiple-aperture plate 30 as shown in FIG. 13 is provided. each injection aperture is installed to direct to each corresponding intake valve 7. The explanation of operation is omitted because it is similar to the embodiment shown in FIG. 2.

Next, the second embodiment of the intake pipe injection type engine according to the present invention will be explained. The composition of the intake pipe injection type engine is similar to the embodiment of shown in FIG. 2.

FIG. 14 shows the second embodiment of the intake pipe injection type engine according to the present invention.

In FIG. 14, Multiple-aperture plate 40 is installed in the frame body 9A at the point of fuel injection valve 9. This multiple-aperture plate 40 is fixed to the frame body 9A at the point of fuel injection valve 9 by guide 12. Valve element 13 is installed at the position opposed to this multiple-aperture plate 40. This valve element 13 can be moved up and down. This valve element 13 connects or disconnects to guide 12 according to the vertical motion. The space is given between valve element 13 and guide 12 by valve element 13 rising with respect to guide 12, and the fuel flows through the space into multiple-aperture plate 40.

Two kinds of the injection apertures 40A and 40B with different diameters, large and small diameters, are installed in this multiple-aperture plate 40. In FIG. 14, a plurality of small injection apertures 40B are arranged on the concentric circle centering on the large injection aperture 40A arranged so that the injection apertures may concentrate by shortening the interval of the injection apertures.

Two kinds of the injection apertures 40A and 40B with different diameters, large and small diameters, are installed in this multiple-aperture plate 40. In FIG. 14, the feature of the configuration is in that a plurality of small injection apertures 40B arranged so that the injection apertures may distribute by lengthening the interval of the injection apertures are arranged on the concentric circle centering on the large injection aperture 40A.

These two kinds of the injection apertures 40A and 40B with different diameters, large and small diameters, are inclined so that large injection aperture 40A concentrated may aim at the skirts of intake valve 7 and small injection aperture 40B distributed may aim at the whole intake valve 7, when fuel injection valve 9 is installed in intake pipe 5.

The kinetic momentum (dispersion speed) of the large droplet injected from injection aperture 40A concentrated is larger than that of small droplet injected from injection aperture 40B distributed, and fuel spray travel becomes longer, when the fuel is injected from fuel injection valve 9 which such multiple-aperture plate 40 is installed in the frame body 9A at the point of the valve. Therefore, the shape of the fuel spray injected from fuel injection valve 9 in which multiple-aperture plate 40 is installed is as shown in FIG. 3. That is, fuel spray 14 injected from fuel injection valve 9 is composed of lead spray 15 injected precedently from large injection aperture 40A of multiple-aperture plate 40, of which fuel spray travel is longer, and main spray 16 injected succedently from small injection aperture 40B of multiple-aperture plate 40, of which fuel spray travel is shorter. The area ratio of the injection aperture is decided so that the mass ratio of lead spray 15 and main spray 16 may become about 1:3 (=The mass of lead spray:that of the main spray). And, the diameter of each injection aperture is decided so as to become this area ratio of the injection aperture.

Next, the operation of fuel injection valve 9 will be explained by using FIG. 16 to FIG. 18.

FIG. 16 shows the state of injection seen from the side of the engine, which is at 20° before the top dead center, the later period of the exhaust stroke.

In FIG. 16, exhaust valve 8 is still open, and the burnt combustion gas of combustion chamber 4 is already pushed out to exhaust pipe 6. Moreover, intake valve 7 is not open yet, and the air flow is hardly generated in intake pipe 5 under such-a condition. Fuel spray 14 composed by lead spray 15 and main spray 16 injected from fuel injection valve 9 progresses toward intake valve 7 without being disturbed by the air flow in intake pipe 5, because the air flow is not caused in intake pipe 5 like this. At this time, lead spray 15 which composes fuel spray 14 is preceded main spray 16 because the diameter of the droplet is large and progresses toward intake valve 7.

When 20° burnt before the top dead center at the later stage of the exhaust stroke as shown in FIG. 16, the throttle valve is shut and the amount of intake air is decreased, because under the low load condition such as idling, the fuel injection amount is small and the combustion is performed at the theoretical air fuel ratio (A/F) 14.7 which is the stoichiometric mixture. Therefore, the pressure in intake pipe 5 is low compared with pressure in combustion chamber 4 under the low load conditions.

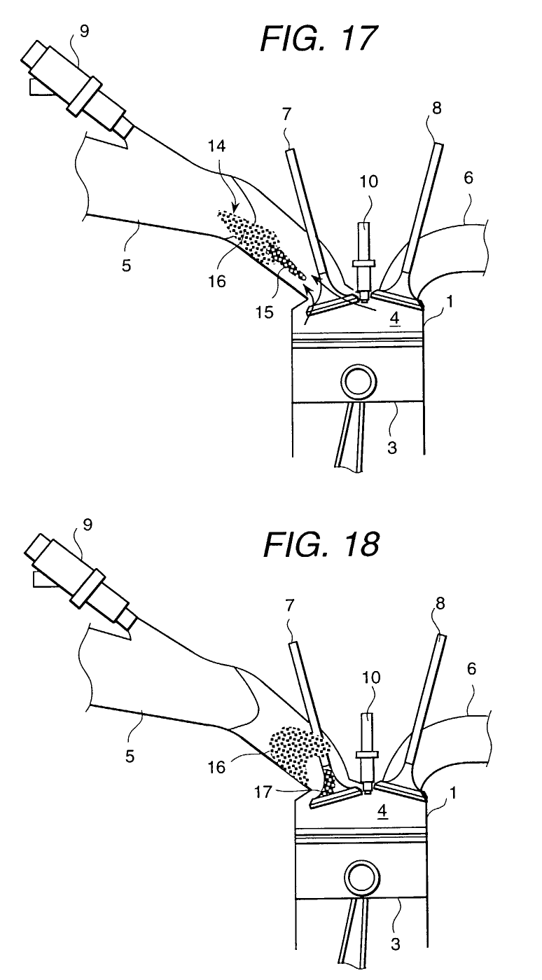

The state of injection seen from the side of the engine, which is at 10° after the top dead center, the previous period of the intake stroke is shown in FIG. 17.

FIG. 17 shows the state that intake valve 7 began to open a little from the state that both intake valve 7 and exhaust valve 8 shut at the exhaust stroke shown in FIG. 16.

In FIG. 17, when intake valve 7 begins to open a little, the pressure in intake pipe 5 is negative and the pressure in combustion chamber 4 is positive just when intake valve 7 is opened. Therefore, the spitting where combustion gas flows backward from combustion chamber 4 to intake pipe 5 by pressure difference in intake pipe 5 and combustion chamber 4 is caused.

lead spray 15 of fuel spray 14 collides with the air flow of the combustion gas generated by the spitting in intake pipe 5, preceding to main spray 16, when the spitting of combustion gas from this combustion chamber 4 to intake pipe 5 is caused.

With regard to the state in which lead spray 15 of such fuel spray 14 collides with the air flow of the combustion gas generated by the spitting, preceding to main spray 16,

If a fuel injection valve with no installation of multiple-aperture plate 40 at the point of fuel injection valve 9 is used, which provides the spray having the conventional spray shape (for instance, the shape of the spray having only the main spray), the spray is disturbed by the spitting from combustion chamber 4 as shown in FIG. 8. As a result, a lot of fuels adhere to the wall surface of intake pipe 5 and liquid film 17 is formed. This liquid film 17 will inflow combustion chamber 4 as the liquid (the state of liquid film 17) without being evaporated, because the temperature in intake pipe 5 is almost near normal. It is not possible to burn completely when it inflows combustion chamber 4 in the state of liquid film 17 like this. Therefore, it is emitted as unburnt hydrocarbon (HC). Further, the time delay entering of the fuel in combustion chamber 4 is occurred, and the response to the best air-fuel ratio is deteriorated.

Moreover, although it is possible to hope for the improvement of the evaporation speed by an increase in the surface area when fuel spray made minute is used. The fuel spray comes to be influenced easily by the spitting from combustion chamber 4, and there is a possibility that the amount of the adhesion to the wall surface of intake pipe 5 increases. Moreover, when spray which has only the lead spray in which the fuel is concentrated by narrowing the angle of spray is used, fuel spray 14 hardly receives the influence of the air flow owing to the strong spray penetration, collides with intake valve 7, and forms the liquid film on the surface of intake valve 7. However, it is not possible to burn completely when the droplet generated from this liquid film by repulsing or tearing off enters combustion chamber 4, because the size of the droplet is large. As a result, unburnt hydrocarbon (HC) is produced. Moreover, the response is deteriorated because the amount of the adhesion increases.

On the contrary, in the embodiment shown in FIG. 14. lead spray 15 of fuel spray 14 collides with the air flow of the spitting from combustion chamber 4, and will counterbalance the power of the air flow of the spitting from combustion chamber 4 as shown in FIG. 18. Because the power of the air flow of the spitting from combustion chamber 4 counterbalanced to lead spray 15 disappears like this, the fuel spray comes not to be blown off easily by the air flow of the spitting. Therefore, the fuel adhesion to the wall surface of intake pipe 5 can be decreased compared with the fuel spray only by the main spray in the prior art. Moreover, there is no delay in sending the fuel injected from fuel injection valve 9 into combustion chamber 4, and the response is improved. In this case, lead spray 15 reaches intake valve 7 and collides with intake valve 7 to form some liquid films 17, although it is counterbalanced to the air flow of the spitting from combustion chamber 4. However, the fuel amount of lead spray 15 is little as a ratio compared with the whole fuel amount, and the thickness of liquid film 17 is very thin. Therefore, a serious problem is not caused, because the size of the droplet generated by repulsing or tearing off is small enough to evaporate.

When piston 3 descends in combustion chamber 4 from the state shown in FIG. 9, the air in intake pipe 5 is inflowed in combustion chamber 4 from the opening of intake valve 7,and lead spray 15 and main spray 16 can form the air-fuel mixture with this air in combustion chamber.

Next, the operation under low load condition in the injection at the intake stroke will be explained.

When intake valve 7 opens and piston 3 descends in the intake stroke, the air in intake pipe 5 is inhaled from the opening of intake valve 7 in combustion chamber 4, and strong air flow is generated in intake pipe 5. the injection at the intake stroke differs from the jet at the exhaust stroke, and the air flow is generated in intake pipe 5 at the fuel injection time like this.

As shown in FIG. 11, surrounding air gets involved by strong penetration lead spray 15 directed to intake valve 7 when fuel spray 14 is injected from fuel injection valve 9 as mentioned above. As a result, jet 18 directed to intake valve 7 is generated in intake pipe 5 besides the air flow generated at the first stage. On the other hand, it is easy for main spray 16 of fuel spray 14 injected from fuel injection valve 9 to be thrown into the air flow because main spray penetration is weaker than lead spray 15. This main spray is induced to jet 18 generated by lead spray 15 and progressively toward intake valve 7, and then inflow in combustion chamber 4 without adhering to the wall surface of intake pipe 5.

Next, the third embodiment of the intake pipe injection type engine according to the present invention will be explained.

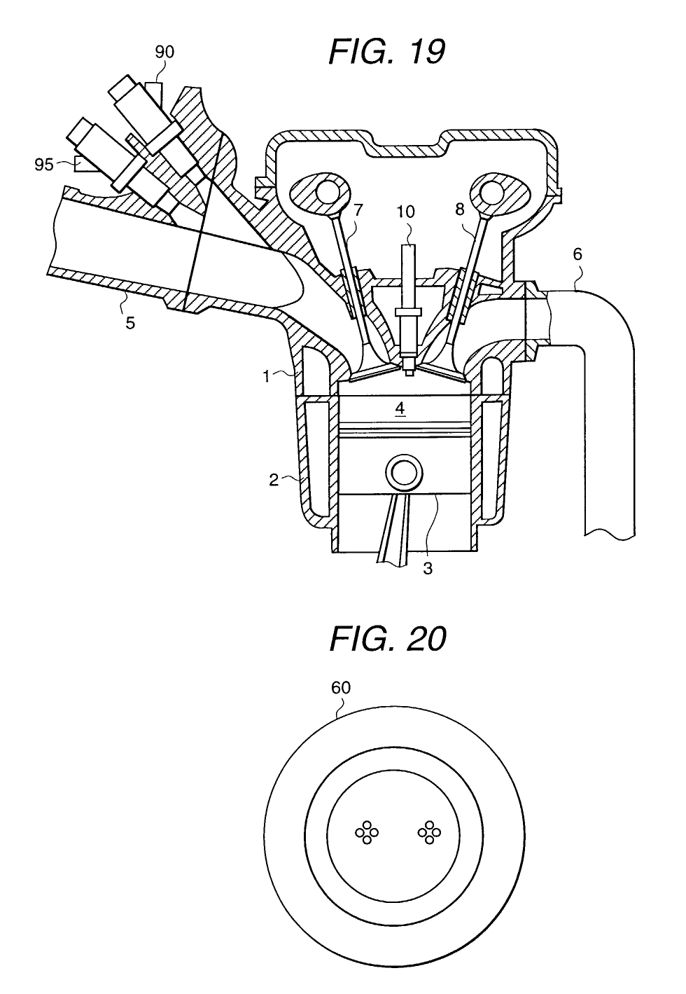

FIG. 19 shows the third embodiment of the intake pipe injection type engine according to the present invention.

FIG. 19 shows the side of the engine in schematic form. A point different from the intake pipe injection type engine shown in FIG. 1 is in that two fuel injection valves 90 and 95 are provided at the positions where the fuel can be injected aiming at intake valve 7. Other configuration is the same as that of FIG. 1.

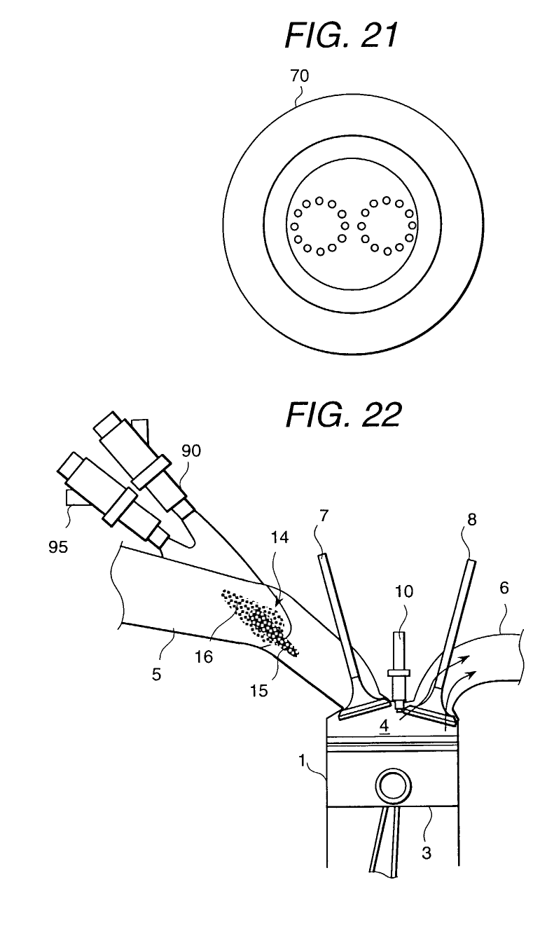

Multiple-aperture plate 60 shown in FIG. 20 is installed in the frame body at the point of fuel injection valve 90, and multiple-aperture plate 70 shown in FIG. 21 is installed in the frame body at the point of fuel injection valve 95. The interval of the injection aperture of this multiple-aperture plate 60 is narrowly provided so that the injected fuel can concentrate and produce the spray with narrow angle of spray. Moreover, multiple-aperture 60 is installed so that the injection aperture may aim at the skirt of intake valve 7 when installed in intake pipe 5. The interval of the injection aperture of multiple-aperture plate 70 is widely provided so that the injected fuel does not interfere with each other and produce the spray with wide angle of spray. Moreover, multiple-aperture 60 is installed so that the injection aperture may aim at whole intake valve 7 when installed in intake pipe 5.

The fuel spray injected from fuel injection valve 90 in which such multiple-aperture plate 60 is installed in the frame body at the point becomes a large droplet injected from the injection apertures concentrated. Its kinetic momentum (dispersion speed) is large, and its fuel spray travel becomes longer. On the otherhand, the fuel spray injected from fuel injection valve 95 in which such multiple-aperture plate 70 is installed in the frame body at the point becomes a small droplet injected from the injection apertures ditributed. It is easy to attenuate because kinetic momentum is dispersed, and its fuel spray travel becomes shorter. When the injection is performed at the same time from fuel injection valves 90 and 95, lead spray 15 with the long fuel spray travel is injected from fuel injection valve 90, and main spray 16 with short fuel spray travel is injected from fuel injection valve 95. Fuel spray 14 composed by these lead spray 15 and main spray 16 travels in intake pipe 5. The injection aperture area ratio of multiple-aperture plate 60 and multiple-aperture plate 70 is decided so that the mass ratio of lead spray 15 and main spray 16 may become about 1:3 (=The mass of lead spray:that of the main spray). And, the diameter of each injection aperture of multiple-aperture plate 60 and multiple-aperture plate 70 is decided so as to become this area ratio of the injection aperture.

Next, the operation of fuel injection valves 90 and 95 will be explained by using FIG. 22 to FIG. 25.

In the operation of these fuel injection valves 90 and 95, the opening and shutting of intake valve 7, the opening and shutting of exhaust valve 8, and fuel injection timing is similar to those in the embodiment shown in FIG. 2. However, the fuel injection timing of fuel injection valves 90 and 95 can take different timing. For instance, you can use the method of injecting main spray 16 by using fuel injection valve 95 in a little time after the injection of lead spray 15 by fuel injection valve 90.

FIG. 22 shows the state of injection seen from the side of the engine, which is at 20° before the top dead center, the later period of the exhaust stroke.

In FIG. 22, exhaust valve 8 is still open, and the burnt combustion gas of combustion chamber 4 is already pushed out to exhaust pipe 6. Moreover, intake valve 7 is not open yet, and the air flow is hardly generated in intake pipe 5 under such a condition. Fuel spray 14 composed by lead spray 15 injected from fuel injection valve 90 and main spray 16 injected from fuel injection valve 95 progresses toward intake valve 7 without being disturbed by the air flow in intake pipe 5, because the air flow is not caused in intake pipe 5 like this. Lead spray 15 and main spray 16 which composes fuel spray 14 intersect on the way. However, lead spray 15 is preceded main spray 16 because the diameter of the droplet is large and progresses toward intake valve 7.

When 20° burnt before the top dead center at the later stage of the exhaust stroke as shown in FIG. 22, the throttle valve is shut and the amount of intake air is decreased, because under the low load condition such as idling, the fuel injection amount is small and the combustion is performed at the theoretical air fuel ratio (A/F) 14.7 which is the stoichiometric mixture. Therefore, the pressure in intake pipe 5 is low compared with pressure in combustion chamber 4 under the low load conditions.

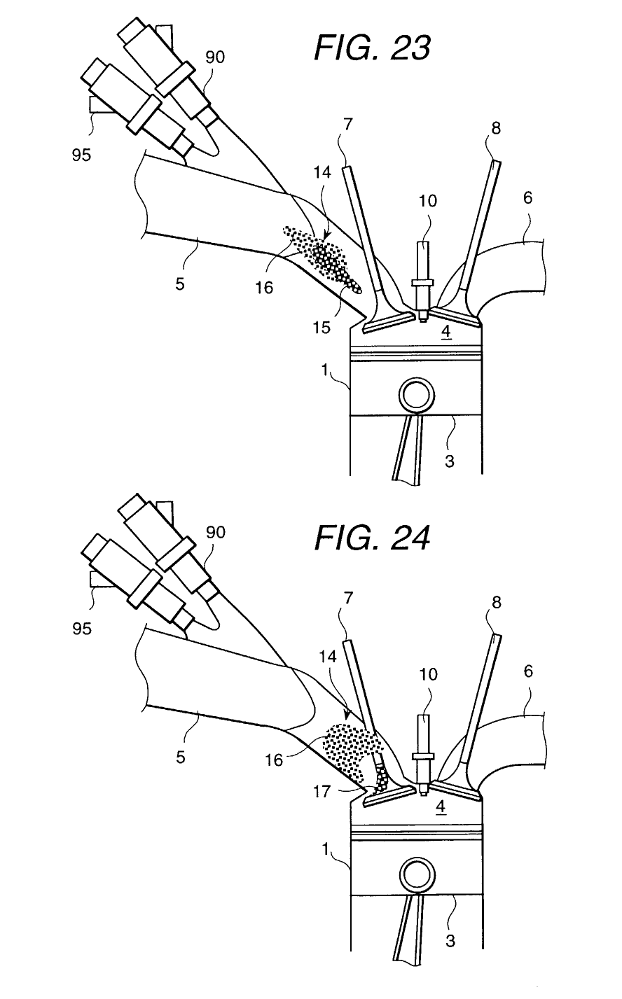

The state of injection seen from the side of the engine, which is at 10° after the top dead center, the previous period of the intake stroke is shown in FIG. 23.

FIG. 23 shows the state that intake valve 7 began to open a little from the state that both intake valve 7 and exhaust valve 8 shut at the exhaust stroke shown in FIG. 22.

In FIG. 23, when intake valve 7 begins to open a little, the pressure in intake pipe 5 is negative and the pressure in combustion chamber 4 is positive just when intake valve 7 is opened. Therefore, the spitting where combustion gas flows backward from combustion chamber 4 to intake pipe 5 by pressure difference in intake pipe 5 and combustion chamber 4 is caused.

lead spray 15 of fuel spray 14 collides with the air flow of the combustion gas generated by the spitting in intake pipe 5, preceding to main spray 16, when the spitting of combustion gas from this combustion chamber 4 to intake pipe 5 is caused.

With regard to the state in which lead spray 15 of such fuel spray 14 collides with the air flow of the combustion gas generated by the spitting, preceding to main spray 16, if two fuel injection valves with no installation of multiple-aperture plate 60 at the point of fuel injection valve 90 and multiple-aperture plate 70 at the point of fuel injection valve 95 are used, which provide the spray having the conventional spray shape (for instance, the shape of the spray having only the main spray), the spray is disturbed by the spitting from combustion chamber 4 as shown in FIG. 8. As a result, a lot of fuels adhere to the wall surface of intake pipe 5 and liquid film 17 is formed. This liquid film 17 will inflow combustion chamber 4 as the liquid (the state of liquid film 17) without being evaporated, because the temperature in intake pipe 5 is almost near normal. It is not possible to burn completely when it inflows combustion chamber 4 in the state of liquid film 17 like this. Therefore, it is emitted as unburnt hydrocarbon (HC). Further, the time delay entering of the fuel in combustion chamber 4 is occurred, and the response to the best air-fuel ratio is deteriorated.

Moreover, although it is possible to hope for the improvement of the evaporation speed by an increase in the surface area when fuel spray made minute is used. The fuel spray comes to be influenced easily by the spitting from combustion chamber 4, and there is a possibility that the amount of the adhesion to the wall surface of intake pipe 5 increases. Moreover, when spray which has only the lead spray in which the fuel is concentrated by narrowing the angle of spray is used, fuel spray 14 hardly receives the influence of the air flow owing to the strong spray penetration, collides with intake valve 7, and forms the liquid film on the surface of intake valve 7. However, it is not possible to burn completely when the droplet generated from this liquid film by repulsing or tearing off enters combustion chamber 4, because the size of the droplet is large. As a result, unburnt hydrocarbon (HC) is produced. Moreover, the response is deteriorated because the amount of the adhesion increases.

On the contrary, in the embodiment shown in FIG. 2. lead spray 15 of fuel spray 14 collides with the air flow of the spitting from combustion chamber 4, and will counterbalance the power of the air flow of the spitting from combustion chamber 4 as shown in FIG. 24. Because the power of the air flow of the spitting from combustion chamber 4 counterbalanced to lead spray 15 disappears like this, the fuel spray comes not to be blown off easily by the air flow of the spitting. Therefore, the fuel adhesion to the wall surface of intake pipe 5 can be decreased compared with the fuel spray only by the main spray in the prior art. Moreover, there is no delay in sending the fuel injected from fuel injection valve 90, 95 into combustion chamber 4, and the response is improved. In this case, lead spray 15 reaches intake valve 7 and collides with intake valve 7 to form some liquid films 17, although it is counterbalanced to the air flow of the spitting from combustion chamber 4. However, the fuel amount of lead spray 15 is little as a ratio compared with the whole fuel amount, and the thickness of liquid film 17 is very thin. Therefore, a serious problem is not caused, because the size of the droplet generated by repulsing or tearing off is small enough to evaporate.

When piston 3 descends in combustion chamber 4 from the state shown in FIG. 24, the air in intake pipe 5 is inflowed in combustion chamber 4 from the opening of intake valve 7,and lead spray 15 and main spray 16 can form the air-fuel mixture with this air in combustion chamber.

Next, the operation under low load condition in the injection at the intake stroke will be explained.

When intake valve 7 opens and piston 3 descends in the intake stroke, the air in intake pipe 5 is inhaled from the opening of intake valve 7 in combustion chamber 4, and strong air flow is generated in intake pipe 5. the injection at the intake stroke differs from the jet at the exhaust stroke, and the air flow is generated in intake pipe 5 at the fuel injection time like this.

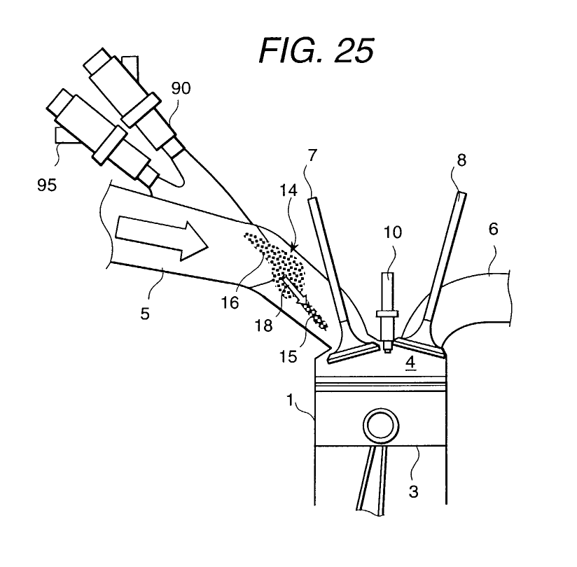

As shown in FIG. 25, surrounding air gets involved by strong penetration lead spray 15 directed to intake valve 7 when fuel spray 14 composed by lead spray 15 injected from fuel injection valve 90 and main spray 16 injected from fuel injection valve 95 is injected into intake pipe 5 as mentioned above. As a result, jet 18 directed to intake valve 7 is generated in intake pipe 5 besides the air flow generated at the first stage. On the other hand, it is easy for main spray 16 of fuel spray 14 injected from fuel injection valve 95 to be thrown into the air flow because main spray penetration is weaker than lead spray 15 injected from fuel injection valve 90. This main spray is induced to jet 18 generated by lead spray 15 injected from fuel injection valve 90 and progressively toward intake valve 7, and then inflow in combustion chamber 4 without adhering to the wall surface of intake pipe 5.

The adhesion of fuel to the wall can be decreased, the hydrocarbon is decreased, and the response can be improved by injecting lead spray of which the spray angle is narrow and the spray penetration is strong, preceding to the main spray of which the spray angle is wide and the spray penetration is weak according to the present invention.

What is claimed is:

1. An intake pipe injection type engine, in which the fuel injection valve is installed in the intake pipe, and the fuel is injected into the intake pipe, wherein
the fuel injection valve injects a main spray of which the spray angle is wide and the spray penetration is weak, and a lead spray of which the spray angle is narrow and the spray penetration is strong.

2. An intake pipe injection type engine according to claim 1, wherein
said fuel injection valve is installed in the intake pipe so that it can be directed to the suction valve.

3. An intake pipe injection type engine according to claim 1 or 2, wherein
said main spray of which the spray angle is wide and the spray penetration is weak and said lead spray of which the spray angle is narrow and the spray penetration is strong are provided by installing a multiple-aperture plate in a nozzle portion of the said fuel injection valve, said multiple-aperture plate having two kind of injection apertures with large and small diameter.

4. An intake pipe injection type engine according to claim 3, wherein
said injection apertures of said multiple-aperture plate comprise a first group of injection apertures of which openings are positioned in close vicinity to each other so that fuel injected from said injection apertures can be concentrated, and a second group of injection apertures of which openings are positioned apart from one another so that the fuel injected from said injection apertures can not interfere with one another.

5. An intake pipe injection type engine according to claim 4, wherein
said first group of injection apertures forms the fuel injection of which fuel injection angle is narrow, and said second group of injection apertures forms the fuel injection of which fuel injection angle is narrow.
